(19) United States
(12) Patent Application Publication
(10) Pub. No.: US 2024/0269018 A1
(43) Pub. Date: Aug. 15, 2024

(54) PERCEPTION-BASED OBSTRUCTION DETECTION SYSTEM FOR A RAMP IN A WHEELCHAIR ACCESSIBLE VEHICLE

(71) Applicant: The Braun Corporation, Winamac, IN (US)

(72) Inventors: Andrew Henseleit, Noblesville, IN (US); Daniel Tallitsch, Western Springs, IL (US)

(21) Appl. No.: 18/436,863

(22) Filed: Feb. 8, 2024

Related U.S. Application Data
(60) Provisional application No. 63/484,000, filed on Feb. 9, 2023.

(51) Int. Cl. A61G 3/06; B60Q 9/00; G01C 21/00

(52) U.S. Cl. CPC A61G 3/061; A61G 3/062; B60Q 9/008; G01C 21/3811

(57) ABSTRACT

An obstruction perception system for a wheelchair accessible vehicle is provided. The system may embody a sensor, such as a camera, that detects objects entering a safety or safety zone surrounding the vehicle's wheelchair access device, such as a ramp or lift. The system may also include a computing system or controller executing machine learning software/algorithms or other logic/instructions for receiving input from the sensor, determining whether obstructions are present, and taking corrective action to prevent the access device from colliding with the obstruction. The computing system may also provide instructions for aligning the vehicle with wheelchair pick-up locations, ensuring sufficient space is available to deploy the ramp in a parking spot, recording events/incidents, providing feedback to the vehicle operator/passenger, and updating vehicle maps.

### CROSS REFERENCE TO OTHER APPLICATIONS

This application claims priority to U.S. Provisional Patent Application No. 63/484,000, filed on 9 Feb. 2023, the contents of which are incorporated herein by reference. This application also incorporates by reference the contents of PCT Application No. PCT/US24/15001, filed 8 Feb. 2024.

### FIELD OF THE DISCLOSURE

The subject technology provides solutions for improving wheelchair accessibility in autonomous vehicles (AVs) and in particular, for enabling automatic operation of a wheelchair access device, such as a ramp or lift, to facilitate the loading and unloading of a passenger wheelchair.

### BACKGROUND

The disclosures of U.S. Pat. No. 11,523,950 B2 and US. Patent Application Publications US2021/0370976A1 and US2022/0234627 A1 are incorporated herein in their entirety. As disclosed therein:

Autonomous vehicles (AVs) are vehicles having computers and control systems that perform driving and navigation tasks that are conventionally performed by a human driver. Automation technology in the autonomous vehicles enables the vehicles to drive on roadways and to accurately and quickly perceive the vehicle's environment, including obstacles, signs, and traffic lights. The vehicles can be used to pick up passengers and drive the passengers to selected destinations. As AV technologies continue to advance, ride-sharing services will increasingly utilize AVs to improve service efficiency and safety. However, for effective use in ride-sharing deployments, AVs will be required to perform many of the functions that are conventionally performed by human drivers, such as performing navigation and routing tasks necessary to provide a safe and efficient ride service. Such tasks may require the collection and processing of large quantities of data using various sensor types, including but not limited to cameras and/or Light Detection and Ranging (LiDAR) sensors disposed on the AV.

For passengers who utilize wheelchairs, entering and exiting vehicles requires many different steps and procedures, including opening a door of the vehicle, deploying a ramp, securing/releasing the wheelchair in the cabin of the vehicle, stowing the ramp, closing the vehicle door, etc. In conventional ridesharing arrangements, human drivers assist passengers with accessibility into an out of the vehicle. For example, human drivers routinely help passengers load/unload and secure accessibility equipment, such as a wheelchairs and other mobility devices. Because human drivers are absent from autonomous vehicle (AV) deployments, there exists a need to provide automated support for the ingress/egress for passengers with special accessibility needs.

In addition, conventional rideshare vehicles are often used to provide rides to destinations with primary drop-off locations on private property. For example, drop-off locations can include hotel lobbies off the main road and houses at the end of long driveways. Additionally, businesses may have main drop-off zones on private property, and some locations may have preferred handicap entrances. However, autonomous vehicles generally do not travel on private property and do not have high fidelity maps of these locations.

Aspects of the prior art technology address the foregoing limitations by providing perception supporting hardware features that facilitate the loading and unloading (ingress/egress) of mobility devices, such as wheelchairs and/or personal scooters. In some aspects, the prior art technology includes AV sensors, e.g. cameras and/or Light Detection and Ranging (LiDAR) sensors that are configured to provide perception capabilities to the computing systems of the wheelchair accessible vehicle (WAV). In some prior art approaches, an AV of the disclosed technology can include reference markers that are disposed on or around certain AV features, such as on a wheelchair ramp, to facilitate AV perception of the accessibility equipment loading/unloading process. Additionally, a restraint system of the AV can be configured to automatically secure one or more pieces of equipment, such as a wheelchair, before a ride is commenced.

Other aspects of the prior art technology address the limitations of vehicles for wheelchair passengers by proving an application on a mobile device for wheelchair passengers to send requests to an/or control wheelchair-accessible systems on an autonomous vehicle. In some aspects of the prior art, a remote computing system may receive a request for a wheelchair-accessible autonomous vehicle (WAV) to execute an ingress function, such as deployment of a wheelchair ramp by the WAV. Furthermore, in response to the request, the remote computing system may send an ingress command to the WAV, such that the ingress command includes instructions to cause the WAV to execute the ingress function. Additionally, the remote computing system may receive feedback from the WAV indicating sensor data associated with the wheelchair ramp and status information associated with the ingress function.

Yet other aspects of the prior art technology provide systems and methods for user-specified location-based autonomous vehicle behavior zones. Public-facing tools can be provided for creation of custom behavior zones, providing a more tailored experience for passengers as well as businesses. Custom behavior zones allow passengers to request or select a specific pick-up/drop-off location on private property, including the identification of wheelchair-accessibility pick-up/drop-off locations.

FIG. 1 illustrates an example prior art system environment 100 that can be used to facilitate AV dispatch and operations, according to some aspects of both the prior art and presently disclosed technology. Autonomous vehicle 102 can navigate about roadways without a human driver based upon sensor signals output by sensor systems 104-106 of autonomous vehicle 102. Autonomous vehicle 102 includes a plurality of sensor systems 104-106 (a first sensor system 104 through an Nth sensor system 106). Sensor systems 104-106 are of different types and are arranged about the autonomous vehicle 102. For example, first sensor system 104 may be a camera sensor system and the Nth sensor system 106 may be a Light Detection and Ranging (LIDAR) sensor system. Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it is contemplated in the prior art that more or fewer sensors may be coupled to the autonomous vehicle 102.

Autonomous vehicle 102 further includes several mechanical systems that are used to effectuate appropriate motion of the autonomous vehicle 102. For instance, the mechanical systems can include but are not limited to, vehicle propulsion system 130, braking system 132, and steering system 134. Vehicle propulsion system 130 may include an electric motor, an internal combustion engine, or both. The braking system 132 can include an engine brake, brake pads, actuators, and/or any other suitable componentry that is configured to assist in decelerating autonomous vehicle 102. In some cases, braking system 132 may charge a battery of the vehicle through regenerative braking. Steering system 134 includes suitable componentry that is configured to control the direction of movement of the autonomous vehicle 102 during navigation. Autonomous vehicle 102 further includes a safety system 136 that can include various lights and signal indicators, parking brake, airbags, etc. Autonomous vehicle 102 further includes a cabin system 138 that can include cabin temperature control systems, in-cabin entertainment systems, etc.

The autonomous vehicle 102 further includes a wheelchair accessibility system 140 that can include various electrical and mechanical systems including, but not limited to, doors, ramps, restraint systems, etc. Wheelchair accessibility system 140 is configured to assist passengers utilizing wheelchairs during ingress and egress of the autonomous vehicle 102.

Autonomous vehicle 102 additionally comprises an internal computing system 110 that is in communication with sensor systems 180 and systems 130, 132, 134, 136, and 138. Internal computing system 110 includes at least one processor and at least one memory having computer-executable instructions that are executed by the processor. The computer-executable instructions can make up one or more services responsible for controlling autonomous vehicle 102, communicating with remote computing system 150, receiving inputs from passengers or human co-pilots, logging metrics regarding data collected by sensor systems 180 and human co-pilots, etc.

Internal computing system 110 can include a control service 112 that is configured to control operation of vehicle propulsion system 130, braking system 132, steering system 134, safety system 136, and cabin system 138. Control service 112 receives sensor signals from sensor systems 180 as well communicates with other services of internal computing system 110 to effectuate operation of autonomous vehicle 102. In some embodiments, control service 112 may carry out operations in concert one or more other systems of autonomous vehicle 102. Internal computing system 110 can also include constraint service 114 to facilitate safe propulsion of autonomous vehicle 102. Constraint service 116 includes instructions for activating a constraint based on a rule-based restriction upon operation of autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of control service 112.

The internal computing system 110 can also include communication service 116. The communication service 116 can include both software and hardware elements for transmitting and receiving signals from/to the remote computing system 150. Communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

Internal computing system 110 can also include latency service 118. Latency service 118 can utilize timestamps on communications to and from remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, latency service 118 can enable other systems of autonomous vehicle 102 or a passenger to make necessary decisions or to provide the needed feedback.

Internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

Remote computing system 150 includes an analysis service 152 that is configured to receive data from autonomous vehicle 102 and analyze the data to train or evaluate machine learning algorithms for operating the autonomous vehicle 102. The analysis service 152 can also perform analysis pertaining to data associated with one or more errors or constraints reported by autonomous vehicle 102. Remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

Remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

Remote computing system 150 can also include rideshare service 158 configured to interact with ridesharing applications 170 operating on (potential) passenger computing devices. Rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc. The ridesharing application 170 can also be configured to receive requests specifically for wheelchair-accessible autonomous vehicles 102. Similarly, ridesharing app 170 can also be configured to receive requests from a passenger for the autonomous vehicle 102 to perform a function and send the request to the rideshare service 158 of the remote computing system 150. The remote computing system 150 can then process the request and send commands to the communication service 116 of the internal computing system of the autonomous vehicle 102, so that the autonomous vehicle 102 can execute the request.

Remote computing system 150 can, in some cases, include at least one computing system 150 as illustrated in or discussed with respect to FIG. 10, or may include at least a subset of the components illustrated in FIG. 10 or discussed with respect to computing system 150.

FIG. 2 shows a prior art environment 200 in which an autonomous vehicle 102 has accessories to be wheelchair accessible. Accordingly, autonomous vehicle 102 is a wheelchair-accessible autonomous vehicle (WAV) 102. More specifically, WAV 102 has automatic doors 202, a wheelchair ramp 210, and a wheelchair restraint system 220. Thus, WAV 102 is configured to accommodate a wheelchair 250 of a passenger and/or a wheelchair passenger 250.

The automatic doors 208 are configured to receive commands from an internal computing system, such as the internal computing system 110, and/or a remote computing system, such as remote computing system 150. The doors 208 can, in response to receiving commands from the internal computing system and/or remote computing system, automatically open and/or close to allow passengers and objects to pass therethrough. For example, wheelchair passenger 250 may send, via an application on a mobile device, a request for the WAV to open doors to a remote computing system. In response to receiving the request, the remote computing system may then send a command to the internal computing system. In response to receiving the command, the internal computing system can then control the doors 208 to open and/or send a command to a system controlling the doors 208 to open the doors 208.

Like doors 208, wheelchair ramp 210 is configured to receive commands from the internal computing system 110 and/or the remote computing system 150. The wheelchair ramp 210 can, in response to receiving commands from the internal computing system and/or remote computing system, automatically load and/or unload to allow wheelchairs to be cross thereon.

Similarly, wheelchair restraint system 220 is configured to receive commands from the internal computing system 110 and/or the remote computing system 150. The wheelchair restraint system 220 can, in response to receiving commands from the internal computing system and/or remote computing system, automatically secure and/or release a wheelchair.

FIG. 3 and FIG. 4 show prior art environments 300a, 300b during various steps of restraining and/or securing the wheelchair 250.

More specifically, FIG. 3 illustrates the wheelchair and/or wheelchair passenger 250 in a cabin of the WAV 102. After the wheelchair passenger 250 has entered the cabin of the WAV 102, the ramp 210 may be loaded back onto WAV 102 and the doors 208 closed. Although not shown, the doors 208 may not be closed yet and/or the ramp may not be loaded yet. Although the wheelchair passenger 250 has enter the cabin of the WAV, the wheelchair restraint system 220 has not yet been engaged. The wheelchair passenger 250 may position the wheelchair in the cabin, such that the wheelchair restraint system 220 may, after being engaged, secure the wheelchair.

FIG. 4 illustrates the wheelchair and/or wheelchair passenger 250 secured by the wheelchair restraint system 220. Furthermore, wheelchair ramp 210 may be loaded back onto WAV 102 and the doors 208 closed. At this time, wheelchair passenger 250 may send information to WAV 102 indicating that the wheelchair passenger 250 is ready for WAV 102 to begin driving. In other words, after the wheelchair and/or wheelchair passenger 250 is properly secured by wheelchair restraint system 220, the doors 208 closed, and the wheelchair ramp 210 loaded, WAV 102 can begin driving.

FIG. 5 illustrates an example prior art accessibility system 200 that facilitates AV ingress/egress of a wheelchair, according to some aspects of both the prior art and presently disclosed technology. Accessibility system 200 includes communication module 202 that is communicatively coupled to ingress/egress perception module 204, and vehicle control module 206.

Communication module 202 can be responsible for receiving commands related to the operation of accessibility controls, such as to facilitate ingress/egress of a wheelchair ramp and/or enlist operations of an accompanying restraint system. By way of example, communications module 202 can be configured for communication with a mobile device and associated applications that can receive requests from a user/rider, and provide notifications to the rider. As such, communications module 202 can facilitate accessibility operations between wheelchair accessible AV, and various users/riders.

In turn, WAV ingress/egress perception module 204 can provide perception needed to track progress of the ingress/egress of accessibility equipment, such as by tracking progress in loading or unloading a wheelchair from an AV, for example, using a wheelchair ramp. As discussed in further detail below, perception functionalities performed by WAV ingress/egress perception module 204 can be facilitated by one or more visual cues/markers that are disposed at locations in the AV.

In conjunction with WAV vehicle controls module 206, WAV ingress/egress perception module 204 can provide functionality needed to automate the assistance process, for example by deploying a wheelchair ramp, tracking the progress of the conveyance of accessibility equipment into the AV, and securing the accessibility equipment using an automated restraint system (not shown).

FIG. 6 illustrates an example of a prior art automated wheelchair ingress/egress process 300. Process 300 begins with step 302 in which one or more visual reference features (e.g., one or more reflective markers) are identified (e.g. by a perception system of the AV) on at least one surface of the AV. In some approaches, multiple reference features of known locations can be used to ascertain the location of equipment within the AV, such as the deployment and retraction of a wheelchair ramp, as well as to track position/location information for one or more pieces of accessibility equipment and/or people boarding or exiting the AV cabin.

By way of example, location information may be ascertained about the wheelchair ramp position and/or a loading status of a wheelchair being loaded or unloaded from the AV based on visual obstructions between one or more of the reference features and one or more AV sensors (e.g. cameras and/or LiDAR sensors, etc.). Although visual markers can be used in some embodiments, it is contemplated in the prior art that the perception system of the prior art technology can be configured to perform tracking and location determinations using only AV sensors (e.g., cameras and/or LiDAR sensors, etc.).

In step 304, a ramp of the AV is automatically deployed to facilitate the ingress of one or more items of mobility equipment (e.g., a wheelchair). It is contemplated in the prior art that other aspects of the AV operation can also be automatically controlled, such as the opening and closing of one or more doors of the AV and/or the automatic harness/release of a restraint system, as discussed in further detail below.

In step 306, ingress of the mobility equipment (wheelchair) is tracked using the reference features. By way of example, visual obstruction of one or more reference features disposed on the wheelchair ramp may indicate a position of the wheelchair on the ramp. Tracking can also continue using one or more visual features that are disposed inside the AV cabin.

In step 308, the mobility equipment can be automatically secured within a cabin of the AV. Similar to step 306, the maneuver and automatic restraint of mobility equipment can be aided using location/position perception that is performed using one or more visual features. However, location/position tracking without the use of visual markers is contemplated. For example, tracking necessary to perform ingress/egress operations may be performed using AV sensor data that is provided to a machine-learning model.

FIG. 7 shows a prior art method 400 for assisting passenger ingress. Method 400 starts at step 402, in which a remote computing system receives a rideshare request to use a wheelchair-accessible autonomous vehicle (WAV). In some embodiments, the remote computing system receives and processes the rideshare request through a rideshare service, such as rideshare service 158.

At step 404, the remote computing system dispatches the WAV to a location of the passenger. In some embodiments, the remote computing system dispatches the WAV through a rideshare service, such as rideshare service 158. The WAV may receive the dispatch information through communication service 116. In some embodiments, the location of the passenger may be determined using location services, such as Global Positioning System (GPS), cellular networks, etc. Similarly, in some embodiments, the passenger may set the location. Accordingly, the location of the passenger may, in some scenarios, be different from an actual position of the passenger when the passenger submits the request.

At step 406, the remote computing system determines that the WAV has arrived at the location of the passenger. The remote computing system may utilize similar location services, cellular networks, etc. to determine a location of both the WAV and the location of the passenger.

At step 408, the remote computing system receives a request for the WAV to execute an ingress function. The request may be sent through a ridesharing application, such as ridesharing app 170. The request may then be received through a rideshare service, such as rideshare service 158. The remote computing system may then process the request and determine the ingress function. In some embodiments, the ingress function may include a deployment of a wheelchair ramp by the WAV and/or loading the wheelchair ramp after the passenger has boarded the WAV. Similarly, in some embodiments, the ingress function may include opening doors of the WAV and/or closing the doors of the WAV after the passenger has boarded the WAV. Likewise, in some embodiments, the ingress function may include engaging an automated restraint system configured to secure the wheelchair in the WAV. In some embodiments, the ingress function may be any combination of the above processes.

At step 410, the remote computing system sends an ingress command to the WAV in response to the request. In some embodiments, the remote computing system sends the command to the internal computing system of the WAV, which receives the command through a communication service, such as communication service 116. The ingress command comprises instructions to cause the WAV to execute the ingress function at a specified pick-up location, such as the location of the passenger.

At step 412, the remote computing system receives feedback from the WAV. As the WAV executes the ingress function, the WAV may send feedback to the remote computing system. In some embodiments, the WAV may send the feedback through a communication service, such as communication service 116. The feedback may include sensor data associated with a door to the WAV, a wheelchair ramp, and/or a wheelchair restraint system. For example, the sensor data may indicate that the wheelchair ramp is being unloaded. Similarly, the feedback may include status information associated with the ingress function. For example, the status information may indicate that a request has been received, that the WAV is executing the ingress function, that the WAV has completed the ingress function, that there is a fault state, etc.

At step 414, the remote computing system sends at least a portion of the feedback to the passenger of the WAV. In some embodiments, the remote computing system may send the feedback to the passenger through a rideshare service, such as rideshare service 158. Accordingly, the passenger will be aware of the status of the WAV executing the ingress function. In some embodiments, the remote computing system may send the status information associated with the ingress function to the passenger. In some embodiments, the remote computing system may send all of the feedback to the passenger.

In some embodiments, at step 416, the remote computing system determines that the status of the function includes a fault state. A fault state may be any state, in which the WAV is unable to complete the ingress function. For example, the WAV may include in the feedback, that a fault state has been detected because the sensors have detected an object passing by, such that the wheelchair ramp cannot be unloaded safely. As another example, the WAV may include in the feedback, that a fault state has been detected because the wheelchair should be moved a few inches to be properly restrained. Thus, the remote computing system can connect the passenger with a remote assistance operator. In some embodiments, the passenger may first resend the request. For example, the passenger may resent the request after moving the wheelchair in a suggested direction to be properly restrained. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the ingress function.

At step 418, the remote computing system receives information from the passenger indicating readiness for the WAV to begin driving. In some embodiments, after the passenger has boarded the WAV and the wheelchair is properly secured and/or restrained, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors in the cabin of the vehicle to determine that the passenger is ready. For example, the WAV may have microphones, such that the WAV may determine that the passenger is ready if the passenger says, “I am ready.” In some embodiments, the ingress functions may include loading the ramp and closing the doors. In other embodiments, the internal computing system may, in response to determining that the passenger is ready, load the ramp, close the doors, and/or secure the wheelchair.

FIG. 8 shows a prior art method 500 for assisting passenger egress. It is contemplated in the prior art that method 500 may be used in conjunction with method 400 and/or alone. Method 500 starts at step 502, in which the remote computing system determines that the WAV has arrived at a destination. The remote computing system may utilize similar location services, cellular networks, etc. to determine a location of both the WAV and the location of the destination.

At step 504, the remote computing system sends an egress command to the WAV. The egress command includes egress instructions to cause the WAV to execute an egress function. In some embodiments, the remote computing system may send the egress command in response to receiving a request for the WAV to execute the egress function. The request may be sent through a ridesharing application, such as ridesharing app 170. The request may then be received through a rideshare service, such as rideshare service 158. The remote computing system may then process the request and determine the egress function. In some embodiments, the egress function may include a deployment of a wheelchair ramp by the WAV and/or loading the wheelchair ramp after the passenger has exited the WAV. Similarly, in some embodiments, the egress function may include opening doors of the WAV and/or closing the doors of the WAV after the passenger has exited the WAV. Likewise, in some embodiments, the egress function may include disengaging an automated restraint system configured to release the wheelchair in the WAV. In some embodiments, the egress function may be any combination of the above processes. In some embodiments, the remote computing system sends the command to the internal computing system of the WAV, which receives the egress command through a communication service, such as communication service 116. The egress command comprises instructions to cause the WAV to execute the egress function at a specified drop-off location, such as the destination.

At step 506, the remote computing system receives egress feedback from the WAV. As the WAV executes the egress function, the WAV may send egress feedback to the remote computing system. In some embodiments, the WAV may send the egress feedback through a communication service, such as communication service 116. The egress feedback may include egress sensor data associated with a door to the WAV, a wheelchair ramp, and/or a wheelchair restraint system. For example, the egress sensor data may indicate that the wheelchair ramp is being unloaded. Similarly, the egress feedback may include status information associated with the egress function. For example, the status information may indicate that a request has been received, that the WAV is executing the egress function, that the WAV has completed the egress function, that there is a fault state, etc.

At step 508, the remote computing system sends at least a portion of the egress feedback to the passenger of the WAV. In some embodiments, the remote computing system may send the egress feedback to the passenger through a rideshare service, such as rideshare service 158. Accordingly, the passenger will be aware of the status of the WAV executing the egress function. In some embodiments, the remote computing system may send the status information associated with the egress function to the passenger. In some embodiments, the remote computing system may send all of the feedback to the passenger.

In some embodiments, at step 510, the remote computing system determines that the status of the egress function includes a fault state. A fault state may be any state, in which the WAV is unable to complete the egress function. For example, the WAV may include in the egress feedback, that a fault state has been detected because the sensors have detected an object passing by, such that the wheelchair ramp cannot be unloaded safely. Thus, the remote computing system connects the passenger with a remote assistance operator. In some embodiments, the passenger may first resend the request. In some embodiments, the remote computing system may automatically connect the passenger with the remote assistance operator. The remote assistance operator may assist the passenger remotely. For example, the remote assistance operator may receive additional sensor data to determine the cause of the fault state. The remote assistance operator may then remotely send commands to the WAV to complete the egress function.

At step 512, the remote computing system receives information from the passenger indicating egress. In other words, the remote computing system receives information from the passenger that the passenger has fully disembarked from the WAV. In some embodiments, after the passenger has exited the WAV, the passenger may send information to the remote computing system and/or the internal computing system of the WAV. In some embodiments, the passenger may send the information through a rideshare app, such as rideshare app 170, on the mobile device of the passenger. In some embodiments, the WAV may have sensors on an exterior of the cabin of the vehicle to determine that the passenger has disembarked from the WAV. For example, the WAV may have cameras on an exterior of the WAV, such that the WAV may determine that the passenger has deboarded when the cameras detect the wheelchair has moved away from the wheelchair ramp. The WAV may then load the wheelchair ramp, close the doors, and begin a new rideshare journey.

FIG. 9 shows a map 600 of a property 602 for custom defining a behavior zone, according to some embodiments of the prior art. In particular, the map 600 shows a property 602 including a building 620 that has a main doorway 612 and a service doorway 616. Additionally, the map 600 shows a ramp 610 to the main door 612, with the bottom of the ramp marked as a wheelchair-accessible drop off location 608.

According to some implementations of the prior art, when a user accesses the map 600 through a portal and/or application, the user selects what type of behavior zone the user would like to add. In the map 600, the user may request to add alternative pick-up/drop-off locations and a wheelchair-accessible pick-up/drop-off location. If the main door entrance is a loading zone (no parking allowed), the user may request to add a loading zone identification. After identifying the type of behavior zone to be added, the user is asked to identify selected locations and to mark certain routes on the map 600.

In particular, to add the wheelchair-accessible pick-up/drop-off location 608, the user selects the corresponding behavior zone type, and then identifies the location 608 on the map 600. Additionally, if the mapping system for the behavior zones does not yet have the entry 604, the driveway 606, and/or the exit 614 mapped, the user will be prompted to identify these locations. After identifying the locations of the entry 604 and the exit 614, the user may be prompted to draw on the map 600 the route 606 from the entry 604 to the exit 614.

Other pick-up/drop/off locations may also be added to the map 600. To add other pick-up/drop-off locations, the user selects the corresponding behavior zone type (e.g., “alternative pick-up/drop-off location”), and then identifies the main door location 612 on the map 600. The user may also choose to identify the service entrance 616.

In some examples, the user can specify where vehicles should wait to pick-up a passenger. In particular, on the map 600, the standing area 618 is a space for vehicles to stand while awaiting passengers. The user can identify the standing area 618 on the map 600 by drawing an outline or circle around the area 618.

FIG. 10 illustrates an example prior art processor-based system with which some aspects of both the prior art and presently disclosed technology can be implemented. For example, processor-based system 700 that can be any computing device making up internal computing system 110, remote computing system 150 and/or a passenger device executing the rideshare app 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 10 illustrates an example prior art processor-based system with which some aspects of the prior art and presently disclosed technology can be implemented. Specifically, FIG. 10 illustrates system architecture 700 wherein the components of the system are in electrical communication with each other using a bus 705. System architecture 700 can include a processing unit (CPU or processor) 710, as well as a cache 712, that are variously coupled to system bus 705. Bus 705 couples various system components including system memory 715, (e.g., read only memory (ROM) 720 and random access memory (RAM) 725, to processor 710.

System architecture 700 can include a cache of high-speed memory connected directly with, in close proximity to, or integrated as part of the processor 710. System architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. Memory 715 can include multiple different types of memory with different performance characteristics. Processor 710 can include any general purpose processor and a hardware module or software module, such as module 1 (732), module 2 (734), and module 3 (736) stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms. In some instances, multimodal systems can enable a user to provide multiple types of input to communicate with the computing system architecture 700. Communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 can include software modules 732, 734, 736 for controlling processor 710. Other hardware or software modules are contemplated. Storage device 730 can be connected to the system bus 705. In one aspect, a hardware module that performs a particular function can include the software component stored in a computer-readable medium in connection with the necessary hardware components, such as the processor 710, bus 705, output device 735, and so forth, to carry out various functions of the disclosed technology.

Embodiments within the scope of the prior art and present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the prior art and present disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### SUMMARY OF THE EMBODIMENTS

While the prior art disclosures cited herein contemplate both automatic deployment of a ramp in a wheelchair accessible vehicle, detection of passing-by objects that prevent the wheelchair ramp from being unloaded safely, and identification of wheelchair pick-up/drop-off locations on an AV map, the disclosures are vague in many respects and lack sufficient disclosure to make and safely use an automatic deploying ramp in an AV. As one example, the disclosures do not contemplate the likelihood of a person or other object obstructing automatic ramp deployment, nor do the disclosures provide logic and methods to detect and respond to such an obstruction. The present disclosure addresses these shortcomings of the cited prior art.

In one embodiment, a computer-implemented method is provided comprising the steps of: monitoring whether an object is present in a safety zone based on input from one or more perception sensors, the safety zone being associated with a wheelchair access device; and if the object is determined to be present in the safety zone, generating an interlock command preventing or stopping operation of the wheelchair access device.

The one or more perception sensors may comprise one or more of a camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone.

The wheelchair access device and the safety zone may be disposed approximate a door opening of a wheelchair accessible vehicle.

The wheelchair access device may be a wheelchair ramp, a wheelchair lift, or other device capable of allowing a wheelchair to move from a surface at one elevation to a different surface at a different elevation.

The method may include the step of setting a boundary for the safety zone based on input from the one or more perception sensors.

The boundary step may be based on a location of at least a portion of a perimeter of the wheelchair access device when the wheelchair access device is disposed in a deployed position.

The boundary step may be based on a location of at least a portion of a perimeter of the wheelchair access device when the wheelchair access device is disposed in the stowed position.

The boundary step may be based on a location of at least a portion of a perimeter of the wheelchair access device when the wheelchair access device is disposed between the deployed position and the stowed position.

The boundary may at least roughly correspond to the portion of the perimeter of the wheelchair access device.

The boundary may be spaced outward from the portion of the perimeter of the wheelchair access device.

The method may include the step of re-setting the boundary if a position or a size of the portion of the perimeter of the wheelchair access device changes.

The method may include the steps of: ascertaining whether the wheelchair access device is operating; and issuing a command to stop operation of the wheelchair access device only if the wheelchair access device is operating and the object is detected in the safety zone.

The ascertaining step may be based on the input from the one or more perception sensors.

The ascertaining step may be based on feedback from the wheelchair access device.

The method may include the step of triggering at least one of a visual and an audible alert if an object is determined to be present in the safety zone.

The method may include the step of providing feedback including a status information associated with the wheelchair access device if an object is determined to be present in the safety zone.

The method may include the step of providing feedback including data associated with the one or more perception sensors if an object is determined to be present in the safety zone.

The method may include the steps of: identifying a location of a wheelchair pick-up/drop-off location based on the input from the one or more perception sensors; and determining if the wheelchair access device is aligned with the wheelchair pick-up/drop-off location based on the input from the one or more perception sensors.

The method may include the step of providing control signals to adjust the position of a vehicle so that the object is outside of the safety region.

The method may include the step of updating a map including a wheelchair pick-up/drop-off location based on the detection of the object in the safety zone.

Any combination of the foregoing methods may be implemented in a wheelchair accessible vehicle comprising a processor executing instructions stored in memory, wherein the instructions comprising the method.

The wheelchair accessible vehicle may be an autonomous vehicle.

Any combination of the foregoing methods may be implemented using a computer-readable storage medium comprising instructions stored therein, which when executed by one or more processors, cause the processors to perform operations comprising the methods.

The computer-readable storage medium may take form as a non-transitory computer-readable storage medium.

Any version of the foregoing computer-readable storage medium may for a part of a system for facilitating deployment or stowage of a wheelchair access device in a wheelchair accessible vehicle, wherein the system further comprises the one or more processors and the one or more perception sensors.

The system for facilitating deployment or stowage of a wheelchair access device in a wheelchair accessible vehicle may include the wheelchair access device.

The system for facilitating deployment or stowage of a wheelchair access device may be present in the wheelchair accessible vehicle.

The wheelchair accessible vehicle may be an autonomous vehicle.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a system environment that can be used to facilitate AV navigation and routing operations, according to some aspects of the prior art and presently disclosed technology.

FIG. 2 illustrates an environment that includes a passenger entering a wheelchair-accessible autonomous vehicle, according to some aspects of the prior art and presently disclosed technology.

FIG. 3 and FIG. 4 illustrate environments during various steps of a passenger entering a wheelchair-accessible autonomous vehicle, according to some aspects of the prior art and presently disclosed technology.

FIG. 5 illustrates an accessibility system that facilitates AV ingress/egress of a wheelchair, according to some aspects of the prior art and presently disclosed technology.

FIG. 6 illustrates a prior art automated wheelchair ingress/egress process.

FIG. 7 illustrates a method for a passenger ingress process, according to some aspects of the prior art and presently disclosed technology.

FIG. 8 illustrates a method for a passenger egress process, according to some aspects of the prior art and presently disclosed technology.

FIG. 9 is a diagram illustrating a map of a property for defining a behavior zone, including a wheelchair pick-up/drop-off location, according to some embodiments of the prior art and present disclosure.

FIG. 10 illustrates a processor-based system with which some aspects of the prior art and presently disclosed technology can be implemented.

FIG. 11 and FIG. 12 illustrate an example environment, in which the wheelchair accessible autonomous vehicle of FIGS. 1-10 is improved to include an obstruction perception system that detects and responds to obstructions that prevent a wheelchair access device from moving uninhibited.

FIG. 13 illustrates the field of view from the obstruction perception system of FIGS. 11 and 12 when the wheelchair access device is fully deployed.

FIG. 14 illustrates the field of view from the obstruction perception system of FIGS. 11 and 12 when the wheelchair access device is moving and an obstruction has entered the path of the wheelchair access device.

FIG. 15 illustrates the field of view from the obstruction perception system of FIGS. 11 and 12 when the wheelchair access device is moving and an obstruction stays outside the path of the wheelchair access device.

FIG. 16 illustrates a method for calibrating the obstruction perception system of FIGS. 11 and 12.

FIG. 17 illustrates a method for the obstruction perception system of FIGS. 11 and 12 to determine whether an obstruction has entered the path of the wheelchair access device.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

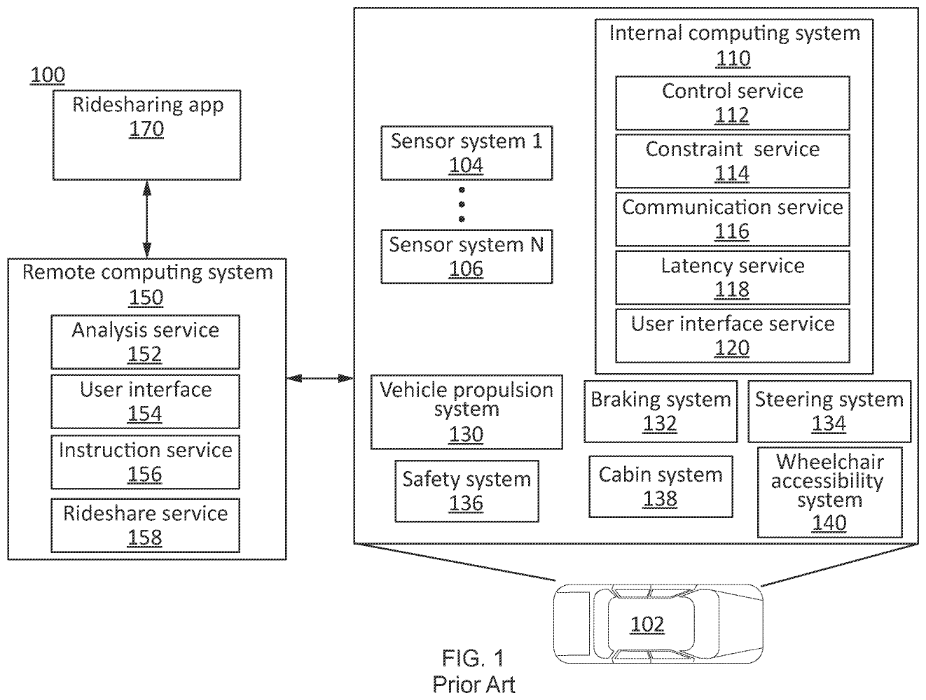

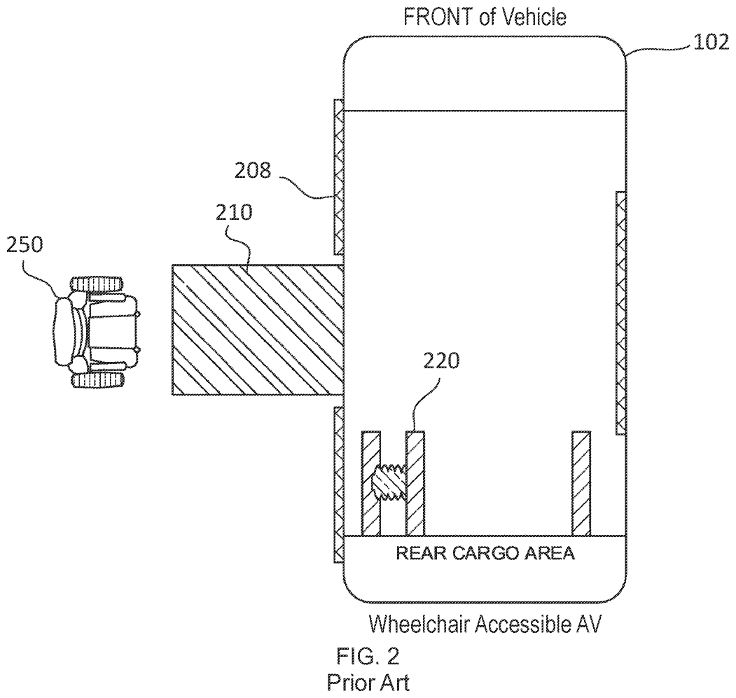

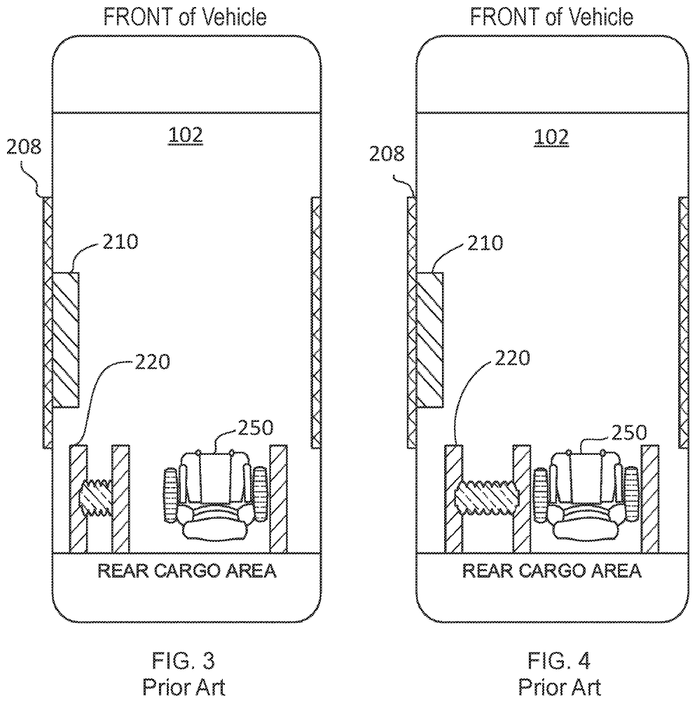

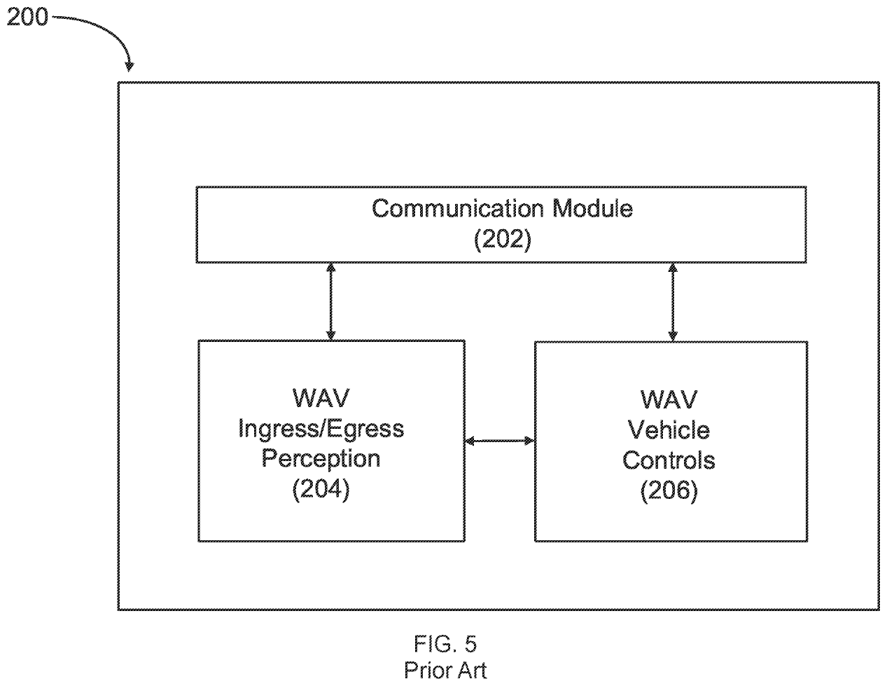

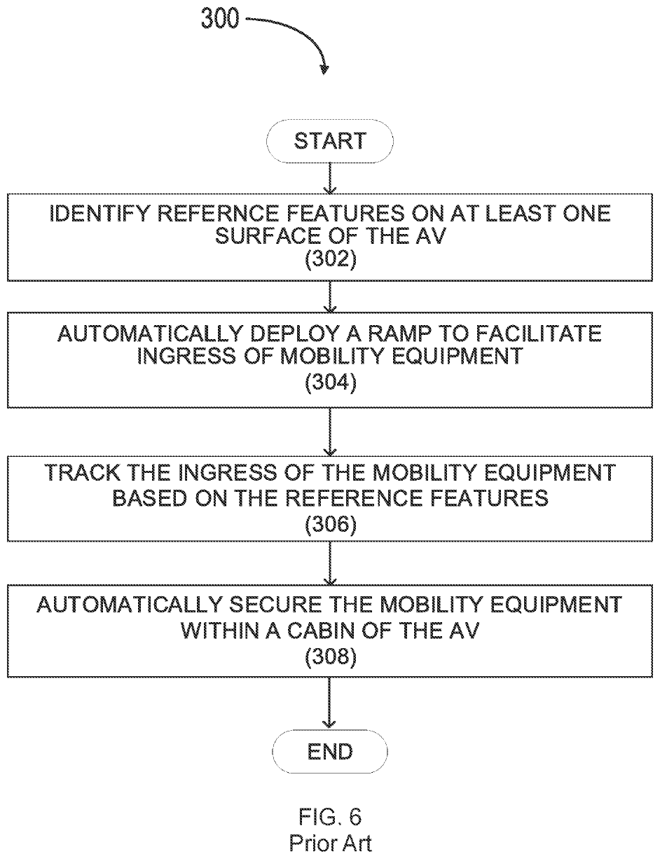

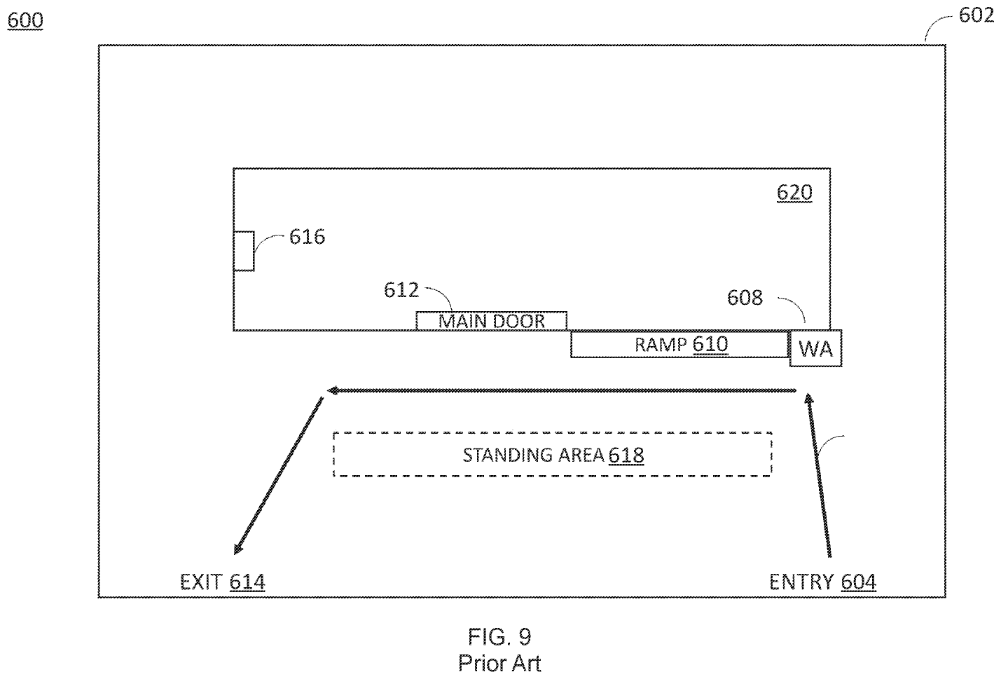

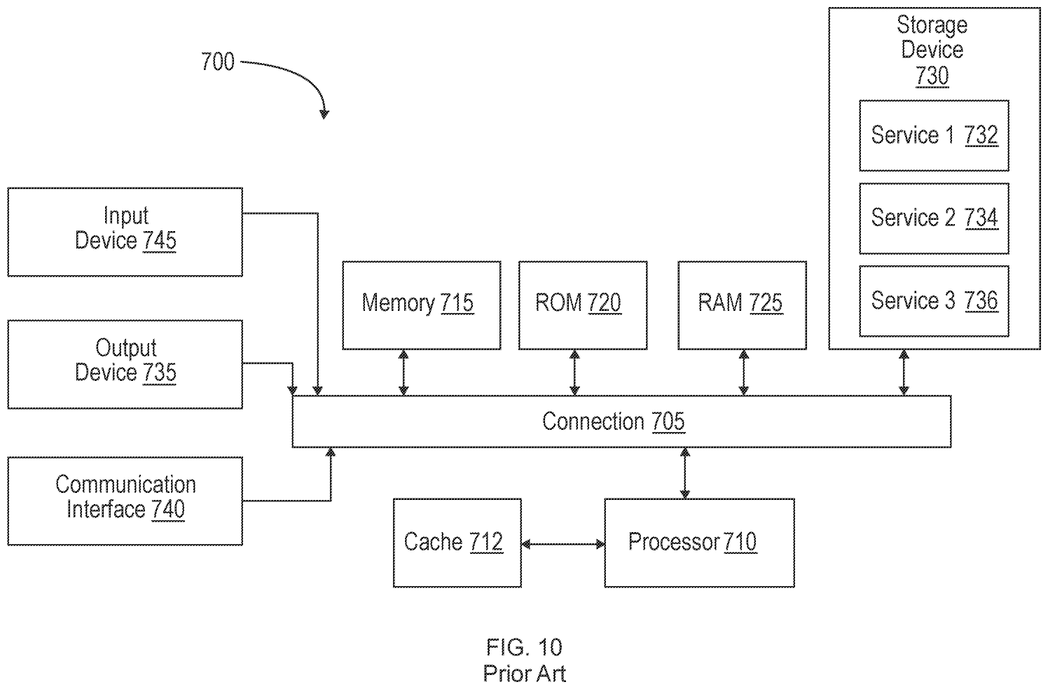

FIGS. 1-10 illustrate various prior art systems, environments, and processes for accommodating a wheelchair passenger 250 in an example autonomous vehicle (AV) 102. These prior art embodiments contemplate automatic deployment of a ramp in a wheelchair accessible vehicle, detection of passing-by objects that prevent the wheelchair ramp from being unloaded safely, and identification of wheelchair pick-up/drop-off locations on an AV map. However, the prior art embodiments suffer from various drawbacks that prevent safe use of an automatic deploying ramp 210. For instance, the prior art disclosures cited herein are abstract and vague and do not contemplate the likelihood of a person or other object obstructing the ramp 210 as it moves from a stowed position (e.g., in the vehicle above or below the floor) to a deployed position outside the vehicle 102 (as shown in FIG. 2) and from the deployed position to the stowed position, nor do the prior art disclosures provide logic and methods to detect and respond to such an obstruction. The present disclosure addresses these shortcomings of the cited prior art by providing obstruction detection apparatus, system, processes, and methods for detecting and responding to obstructions prior to the ramp 210 making contact with the obstruction.

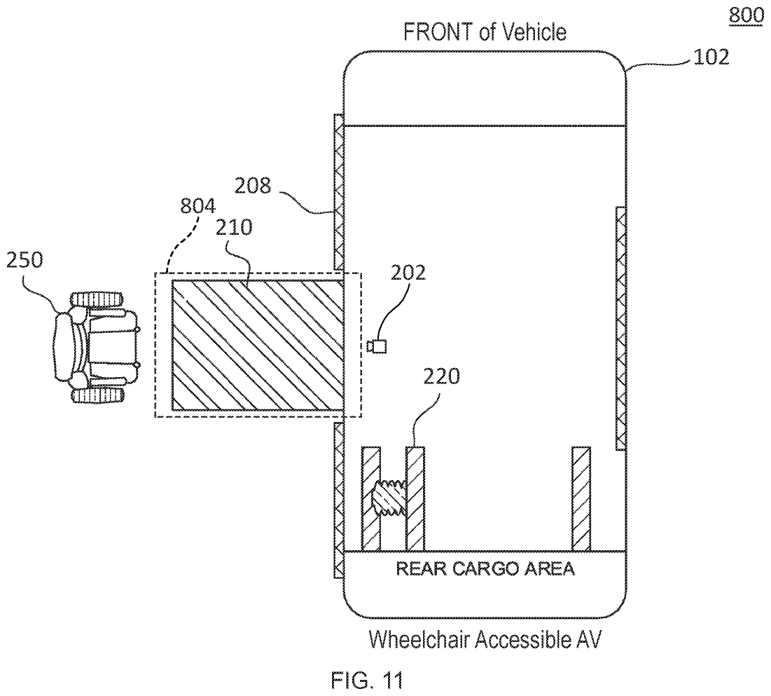

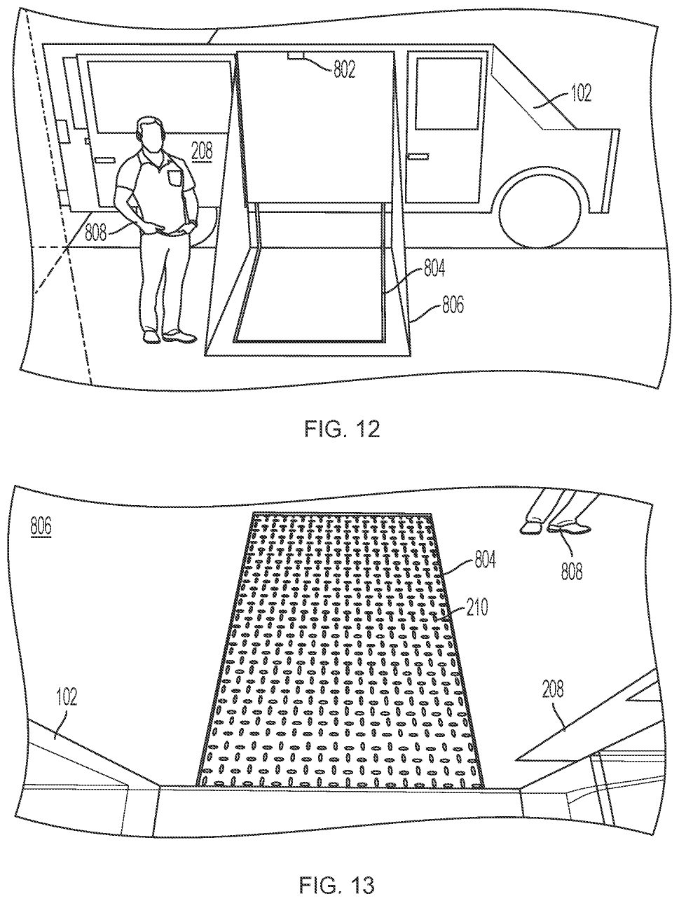

Accordingly, FIGS. 11-12 illustrate an example environment 800, in which the wheelchair accessible autonomous vehicle 102 of FIGS. 1-10 is improved to include accessories that detect and respond to obstructions that prevent ramp 210 (or other wheelchair access devices, such as a wheelchair lift) from moving uninhibited from a stowed position to a deployed position and vice versa. The vehicle 102 may be provided with at least one perception sensor 802 that is positioned to perceive obstructions in wheelchair ramp safety (or threshold) region 804, which may include at least a portion of the area occupied by the wheelchair ramp 210 in either or both its deployed and stowed position. As described in further detail below, the wheelchair ramp safety zone 804 may correspond exactly with at least a portion of the perimeter of the ramp 210, or it may include surrounding boundary regions along any one or more of the four sides of the ramp 210.

The perception sensor 802 may take form as a single sensor or multiple sensors comprising one or more of any of the following: the camera sensor system 104, the Light Detection and Ranging sensor system (LIDAR) 106, and the other exemplary sensor systems described in the Background section above (e.g., RADAR, EmDAR, SONAR, SODAR, GNSS, GPS, accelerometers, gyroscopes, IMU, infrared, laser, ultrasonic, infrasonic sensor systems, microphones, etc.) and a Time-of-Flight sensor (ToF). The perception sensor 802 may be mounted internal to the cabin of the vehicle (e.g., in the ceiling, the opposite wall or door, or a pillar of the vehicle, etc.) or external to the vehicle (e.g., above, to either side, or below the door opening, etc.). The perception sensor 802 may include a wide field of view 806 and may be capable of monitoring not only at least a large fraction of the region occupied by the ramp 210 in the deployed and/or stowed positions (e.g., the wheelchair ramp safety zone 804), but also surrounding regions and possibly at least some portion of the area inside of the vehicle cabin, particularly if the ramp has a stowed position in the cabin above the vehicle floor.

The internal computing system 110 of the vehicle may be in communication with and receive input from the perception sensor 802. The internal computing system 110 processor may execute instructions (e.g., machine learning software/algorithms) stored in the memory to receive and process the input, calibrate the system/identify thresholds/safety zones, determine whether ramp obstructions exist, and/or take corrective action (e.g., send corrective action signals to the wheelchair accessibility system 140), as described in more detail below.

The wheelchair ramp safety zone 804 may be factory preset/pre-coded in the internal computing system 110 memory.

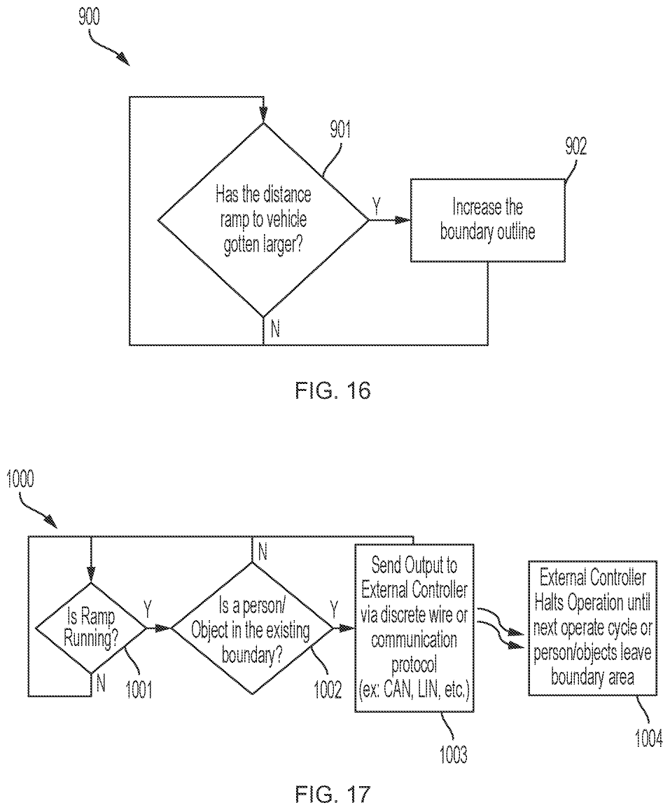

Additionally or alternatively, the internal computing system 110 may include artificial intelligence or other machine learning software/algorithms to automatically set, re-set, and/or calibrate the wheelchair ramp safety zone 804 based upon actual perceptions from the perception sensor 802. In one embodiment, the wheelchair ramp safety zone 804 may be set/re-set/calibrated when the ramp 210 is fully deployed, as best illustrated in FIG. 13 from the perception sensor's 802 point of view 806. Based on input from the perception sensor 802, the internal computing system 110 processor may identify the area occupied by the deployed ramp 210 and create a boundary box around it (i.e., the boundary of the wheelchair ramp safety zone 804) (or modify an existing boundary box/safety zone 804 stored in memory). In one example, the internal computing system 110 will execute the logic 900 set forth in FIG. 16. In Step 901, the internal computing system 110 will evaluate input from the perception sensor 802 to determine if the distance from the ramp 210 to the vehicle 110 (or alternatively, the area occupied by the ramp 210) is larger than the distance (or alternatively, the safety zone 804) currently stored in memory. If the internal computing system 110 detects an increase, the internal computing system will proceed to perform Step 902. In Step 902, the internal computing system 110 increases the boundary outline (i.e., the safety zone 804) stored in memory and used in subsequent processes described herein.

Additionally or alternatively, the internal computing system 110 processor may set/re-set/calibrate the wheelchair ramp safety zone 804 based on input from the perception sensor 802 with the ramp 210 in the fully stowed position and/or at any or multiple positions between the deployed and stowed position, and enlarge or shrink the wheelchair ramp safety zone 804 accordingly.

The “boundary box” used to define the wheelchair ramp safety zone 804 may correspond to, closely correspond, or roughly correspond to the perceived perimeter of the wheelchair ramp 210. Alternatively, the boundary box may be simply based upon the perceived perimeter of the wheelchair ramp 210. For example, the boundary box may be enlarged along any one or more of the four sides of the ramp 210 to provide a buffer zone around the ramp 210. The size of the buffer zone may be pre-coded within the internal computing system 110 instructions, or can be customizable by the vehicle owner/operator or end user through any one or more of the vehicle inputs (including but not limited to the rideshare app 170, user interface 154, cabin system 138/user interface system 120).

Once the wheelchair ramp safety zone 804 is set, the internal computing system 110 processor may evaluate input from the perception sensor 802 to detect the presence of obstructions in the wheelchair ramp safety zone 804. The internal computing system 110 processor may also evaluate input from the perception sensor 802 to detect the presence and/or movement of the ramp 210. The internal computing system 110 may alternatively or additionally receive feedback from the wheelchair accessibility system 140 (e.g., ramp 210 controller), where the feedback is indicative of ramp 210 status (deployed/between deployed and stowed/stowed, moving/stationary, fault, etc.).

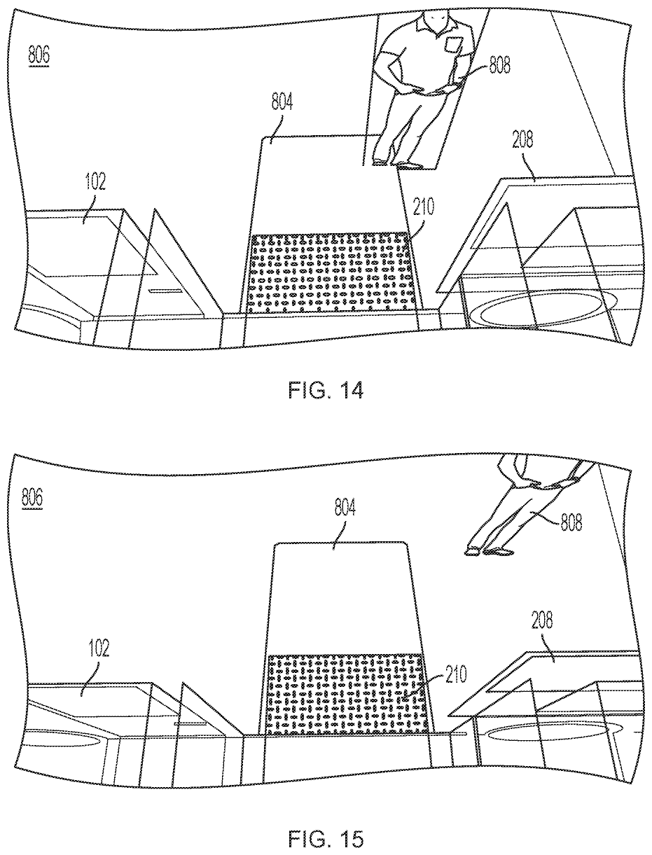

In one implementation, the internal computing system 110 may programmed to prevent ramp 210 operation any time an obstruction is present in the wheelchair ramp safety zone 804. For instance, the internal computing system may issue a ramp stop/interlock command or signal to the wheelchair accessibility system 140 any time it determines that an obstruction is present in the wheelchair ramp safety zone 804. See, e.g., FIG. 14 which illustrates from the perception sensor's 802 point of view 806 that an obstruction 808 has entered the wheelchair ramp safety zone 804. In the case of FIG. 14, the internal computing system 110 would issue the wheelchair stop/interlock command. Responsive to the wheelchair stop/interlock command or signal, the wheelchair accessibility system 140 (e.g., a wheelchair ramp controller) will either stop or prevent the ramp 210 from operating and may issue an audible and/or visual alert in the vehicle 102. Alternatively, the internal computing system 110 may by default issue a ramp safe command or signal any time the wheelchair ramp safety zone 804 is clear of anything except for the ramp 210 itself and cease issuing the ramp safe command any time it determines that an obstruction is present in the wheelchair ramp safety zone 804. See, e.g., FIG. 15 which illustrates from the perception sensor's 802 point of view 806 that there are no obstructions in the wheelchair ramp safety zone 804; only the ramp 210 is present in the wheelchair safety zone. In the case of FIG. 15, the internal computing system 110 would issue the ramp safe signal. The wheelchair accessibility system 140 (e.g., the wheelchair ramp controller) may be configured to only operate the ramp when it is receiving the ramp safe command and may issue an audible and/or visual alert in the vehicle in the absence of such a ramp safe command.

In a second implementation, the internal computing system 110 may be programmed to prevent ramp 210 operation any time both an obstruction and the ramp are present in the wheelchair ramp safety zones 804. For instance, the internal computing system 110 may issue a ramp stop command or signal any time it both: (a) determines that an obstruction is present in the wheelchair ramp safety zone 804; and (b) determines or receives feedback from the wheelchair accessibility system that the ramp 210 is either present in the wheelchair ramp safety zone 804 (i.e., stowed or between deployed and stowed) or moving. See, e.g., FIG. 14 which illustrates from the perception sensor's 802 point of view 806 that both an obstruction 808 and the ramp 210 has entered the wheelchair ramp safety zone 804. In the case of FIG. 14, the internal computing system 110 would issue the wheelchair stop/interlock command. Responsive to the wheelchair stop/interlock command or signal, the wheelchair accessibility system 140 (e.g., a wheelchair ramp controller) will either stop or prevent the ramp 210 from operating and may issue an audible and/or visual alert in the vehicle 102. Alternatively, the internal computing system 110 may by default issue a ramp safe command or signal any time the wheelchair ramp safety zone is clear of everything except for the ramp 210 itself and cease issuing the ramp safe command any time it both: (a) determines that an obstruction is present in the wheelchair ramp safety zone 804; and (b) determines or receives feedback from the wheelchair accessibility system that the ramp 210 is either present in the wheelchair ramp safety zone (i.e., stowed or between deployed and stowed) or moving. See, e.g., FIG. 15 which illustrates from the perception sensor's 802 point of view 806 that there are no obstructions in the wheelchair ramp safety zone 804; only the ramp 210 is present in the wheelchair safety zone. In the case of FIG. 15, the internal computing system 110 would issue the ramp safe signal. The wheelchair accessibility system 144 (e.g., the wheelchair ramp controller) may be configured to only operate the ramp when it is receiving the ramp safe command and may issue an audible and/or visual alert in the vehicle in the absence of such a ramp safe command.

In a third implementation, the internal computing system 110 may execute the logic 1000 set forth in FIG. 17. Specifically, in Step 1001, the internal computing system 110 will repeatedly check to see if the ramp 210 is running (i.e., moving between the deployed position and the stowed position, in either direction). One the internal computing system 110 determines or otherwise learns (e.g., from ramp feedback) that the ramp 210 is running, the internal computing system 110 will perform Step 1002. Specifically, in Step 1002, the internal computing system 110 evaluates input from the perception sensor 802 to determine if an obstruction (e.g., a person or object) is within the safety zone 804. If no such obstruction is detected, the internal computing system 110 will proceed back to performing Step 1001. If an obstruction is detected, the internal computing system will proceed to Step 1003. In Step 1003, the internal computing system 110 will send an output signal to the wheelchair accessibility system 140 (e.g., a wheelchair ramp controller). Upon receive of the output signal, the wheelchair accessibility system 140 will perform Step 1004. In particular, responsive to the output signal from the internal computing system 110, the wheelchair accessibility system 140 halt operation of ramp 210 until it receives a next instruction to operate or until the obstruction leaves the safety zone 804. In the meantime, the internal computing system 110 will proceed back to performing Step 1001.

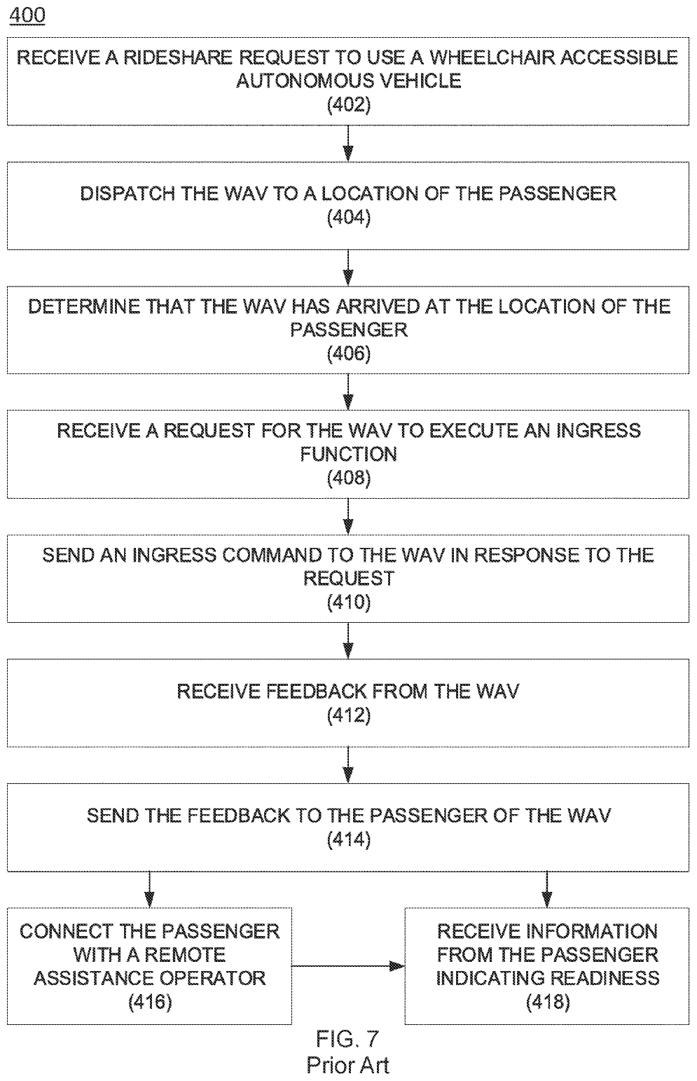

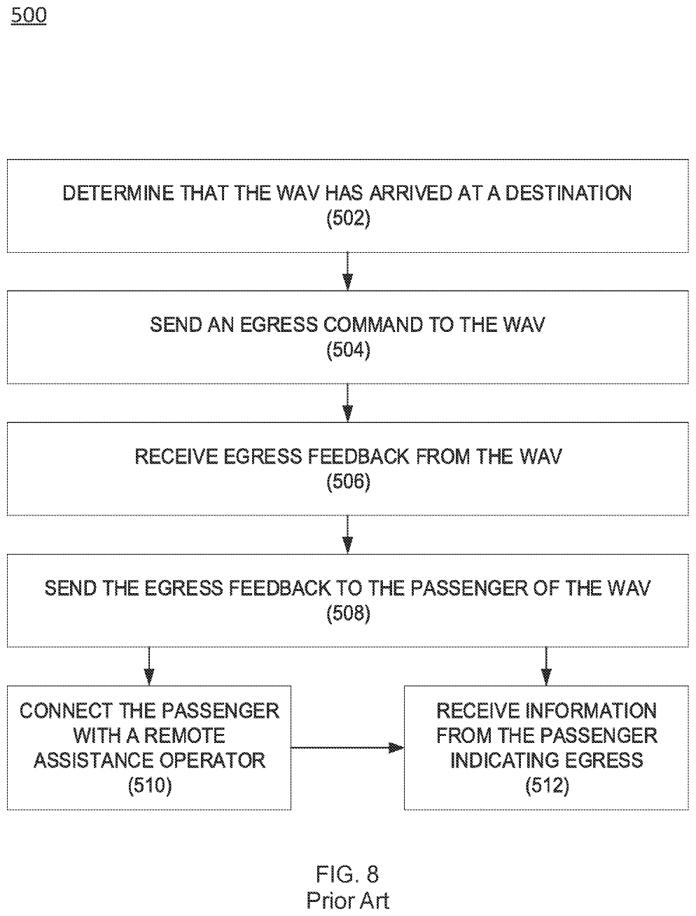

After a wheelchair stop/interlock command is issued (or a ramp safe command ceases to be issued), additional instructions may be executed within the internal computing system 110 to take corrective action, including reversing the direction of movement of the ramp 210 (e.g., for example, if the ramp 210 was being deployed from the stowed position, the internal computing system 110 may issue commands/signals to the wheelchair accessibility system 140 to move the ramp 210 back to the stowed position, and vice versa). Additionally or alternatively, the processes described in the Background section above for FIGS. 7 and 8, particularly steps 412, 414, 416, 418, 506, 508, 510, and/or 512 may be executed after a wheelchair stop/interlock command is issued (or a ramp safe command ceases to be issued) to provide feedback of the wheelchair ramp fault (i.e., obstruction preventing deployment or stowage) to the remote computing system 150, a vehicle operator, and/or a rideshare passenger and/or to connect the passenger with a remote assistance operator for further assistance. Additionally or alternatively, the internal computing system 110 may cause audible and/or visual alerts to be issued in the vehicle 102 via user interface system 120/cabin system 138. Additionally or alternative, the internal computing system 110 may include event recording functions, whereby images or video of the ramp 210 deployment/stowage event in question is stored into local memory or transmitted to the remote computing system 150, for later evaluation of the event.

Even further, to the extent that an obstruction (e.g., a fixed obstruction) is perceived at a given location, maps used by the vehicle and/or rideshare app (e.g., maps stored/used in internal computing system 110 memory, stored/used by the remote computing system 150, or stored/used in the rideshare service 158) may be updated to reflect that the given location is not usable as wheelchair pick-up/drop-off location. In one implementation, a behavior map 600 may be modified to either reject or move the wheelchair pick-up/drop-off location 608.

Additionally or alternatively, to the extent that an obstruction is not perceived during a successful ramp deployment and stowage at a given location, maps used by the vehicle and/or rideshare app (e.g., maps stored/used in internal computing system 110 memory, stored/used by the remote computing system 150, or stored/used in the rideshare service 158) may be automatically updated to reflect that the given location is suitable as a wheelchair pick-up/drop-off location. In one implementation, a behavior map 600 may be automatically modified to set a wheelchair pick-up/drop-off location 608.

To increase the accuracy of the proposed obstruction detection system, the perception sensor 802 may comprise both a camera 104 and a LIDAR module 106. The LIDAR module 106 will provide a secondary data point as internal computing system 110 cannot easily tell distance from camera 104 input alone. The LIDAR module 106 could take form as any other sensor capable of providing distance data to the internal computing system 110, such as a Time-of-Flight sensor or an ultrasonic sensor (distance data alone is sufficient since the location of the door opening and ramp is known). Alternatively, similar results may be achieved with a 360-degree LIDAR sensor, which could ascertain distance and location due to the spinning portion.

In an alternative implementation, the perception sensor 802 could comprise one or more standard LIDAR and/or ToF sensors in the absence of a machine learning/camera portion. For instance, multiple such sensors arranged according could provide data indicative of you could tell the distance to object and know if it falls in the range of your ramp and then execute the same procedure to notify the ramp control module.

The obstruction perception system of the present disclosure may be provided with additional functionality to assist vehicle 102 parking. For instance, the internal computing system 110 may provide a signal/output indicative of another vehicle being present in the wheelchair ramp safety zone 804, which may then provide feedback to the vehicle owner/operator or passenger via user interface service 120/cabin system 138, user interface 154 of the remote computing system, and rideshare app 170. Additionally, the obstruction perception system implemented in the internal computing system 110 may be configured to provide control signals for the vehicle 102 guidance and control systems (e.g., vehicle propulsion system 130, braking system 132, and steering system 134) to cause vehicle 102 may take corrective action, including steering away from the other vehicle to provide sufficient room for the wheelchair ramp 210 to deploy. As another example, the obstruction perception system implemented by the internal computing system 110 may be configured to detect the boundaries (or length) of a wheelchair pickup/drop off location/platform based on input from the perception sensor 802, in which case the internal computing system 110 may be configured to provide control signals for the vehicle 102 guidance and control systems (e.g., vehicle propulsion system 130, braking system 132, and steering system 134) to cause vehicle 102 to stop when the ramp 210 and/or the wheelchair ramp safety zone is at a predetermined position within the boundaries/length (e.g., approximately or roughly centered with the wheelchair pick-up/drop-off location/platform).

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

In one such departure, the obstruction perception system described herein may be used to detect and respond to obstructions to deployment/use/stowage of other types of vehicle access systems, such as wheelchair lifts.

In another such departure, the embodiments described herein for detecting and responding to obstructions preventing ramp/lift deployment may be incorporated as described in vehicles that are not or not fully autonomous. Additionally, a self-contained obstruction perception system can be used in any vehicle, autonomous or not. In the self-contained system, the perception sensor 802 may be a USB or any other type of digital camera (or other perception sensor described above) that connects to a stand-alone module that runs the above-described machine learning software/algorithms. The hardware module could be an off the shelf computing system/controller (NVIDIA Jetson, ST Micro eval kits, etc.) or purpose built by the manufacturer. It is contemplated that commands from such a stand-alone system will be fed to a ramp/lift control using known communication methods, including but not limited to a single wire, or more complex communications such as a CAN or LIN message.

In yet another such departure, the features and functions of the obstruction perception system and its interaction with/feedback to/input from the rideshare service 158 and ridesharing app 170 may be provided in relation to a vehicle owner's interactive app, such as the My BMW and FordPass apps.

1. A system for facilitating deployment or stowage of a wheelchair access device in a wheelchair accessible vehicle, comprising:
one or more processors;
a wheelchair access device being moveable between a deployed position and a stowed position;
one or more perception sensors configured to perceive at least a portion of the wheelchair access device when the wheelchair access device is positioned in at least one of the deployed position and the stowed position;
a non-transitory computer-readable medium coupled to the one or more processors, wherein the computer readable medium comprises instructions, which when executed by the one or more processors, cause the one or more processors to perform operations comprising:
monitoring whether an object is present in a safety zone based on input from the one or more perception sensors;
if the object is determined to be present in the safety zone, generating an interlock command preventing, stopping, or reversing operation of the wheelchair access device.

2. The system of claim 1, wherein the one or more perception sensors comprises one or more of a camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone.

3. The system of claim 1, wherein the wheelchair access device and the safety zone are disposed approximate a door opening of the wheelchair accessible vehicle.

4. The system of claim 1, wherein the wheelchair access device is one of a wheelchair ramp and a wheelchair lift.

5. The system of claim 1, wherein the one or more processors are further configured to execute operations comprising:
setting a boundary for the safety zone based on input from the one or more perception sensors.

6. The system of claim 5, wherein the boundary at least roughly corresponds to the portion of the perimeter of the wheelchair access device.

7. The system of claim 5, wherein the one or more processors are further configured to execute operations comprising:
re-setting the boundary if a position or a size of the portion of the perimeter of the wheelchair access device changes.

8. The system of claim 1, wherein the one or more processors are further configured to execute operations comprising:
ascertaining whether the wheelchair access device is operating;
issuing a command to stop operation of the wheelchair access device only if the wheelchair access device is operating and an object is detected in the safety zone.

9. The system of claim 8, wherein the ascertaining operation is based on the input from the one or more perception sensors.

10. The system of claim 8, wherein the ascertaining operation is based on feedback from the wheelchair access device.

11. The system of claim 1, wherein the one or more processors are further configured to execute operations comprising:
if an object is determined to be present in the safety zone, triggering at least one of a visual and an audible alert.

12. The system of claim 1, wherein the one or more processors are further configured to execute operations comprising:
if an object is determined to be present in the safety zone, providing feedback including a status information associated with the wheelchair access device.

13. The system of claim 1, wherein the one or more processors are further configured to execute operations comprising:
if an object is determined to be present in the safety zone, providing feedback including data associated with the one or more perception sensors.

14. The system of claim 1, wherein the one or more processors are further configured to execute operations comprising:
identifying a location of a wheelchair pick-up/drop-off location based on the input from the one or more perception sensors;
determining if the wheelchair access device is aligned with the wheelchair pick-up/drop-off location based on the input from the one or more perception sensors.

15. The system of claim 1, wherein the one or more processors are further configured to execute operations comprising:
providing control signals to adjust the position of the vehicle so that the object is outside of the safety region.

16. The system of claim 1, wherein the one or more processors are further configured to execute operations comprising:
updating a map including a wheelchair pick-up/drop-off location based on the detection of the object in the safety zone.

17. The system of claim 1 further comprising the vehicle.

18. The system of claim 17, wherein the vehicle is an autonomous vehicle.

19. A computer-implemented method comprising the steps of:
monitoring whether an object is present in a safety zone based on input from one or more perception sensors, the safety zone being associated with a wheelchair access device;
if the object is determined to be present in the safety zone, generating an interlock command preventing, stopping, or reversing operation of the wheelchair access device.

20. A wheelchair accessible vehicle comprising a processor executing instructions stored in memory, the instructions comprising the method of claim 19.
